(19) United States
(12) Patent Application Publication
(10) Pub. No.: US 2010/0085481 A1
(43) Pub. Date: Apr. 8, 2010

(54) Frame based video matching

(76) Inventors: Alexandre Winter, Washington, DC (US); Christian Wengert, Paris (FR); Simon Dolle, Issy les Moulineaux (FR); Frederic Jahard, Vincennes (FR)

Correspondence Address: MICHAUD-Kinney Group LLP, 306 INDUSTRIAL PARK ROAD, SUITE 206, MIDDLETOWN, CT, 06457, US

(21) Appl. No.: 12/460,903

(22) Filed: Jul. 23, 2009

Related U.S. Application Data
(60) Provisional application No. 61/082,961, filed on Jul. 23, 2008.

(51) Int. Cl. H04N 9/475

(52) U.S. Cl. 348/513; 348/E05.009

(57) ABSTRACT

A method for identifying videos within a corpus of reference videos that match a query video is presented. The method includes receiving an input search criteria including search and matching parameters. The method includes indexing each reference video frame by frame and determining a visual signature based on visual signatures of all frames or a subset of frames. The method also includes determining a visual signature of the query video and comparing the visual signatures of each reference video to the query video and identifying matches. In one embodiment, indexing includes determining subsets of frames within each reference video including anchor, heart beat and key frames. A primary visual signature is based on the visual signatures of all frames within the reference video. A secondary visual signature is based on the visual signatures of at least one of the subsets within the reference video.

### CROSS-REFERENCE TO RELATED APPLICATIONS

This patent application claims priority benefit under 35 U.S.C. §119(e) of copending, U.S. Provisional Patent Application Ser. No. 61/082,961, filed Jul. 23, 2008, the disclosure of this U.S. patent application is incorporated by reference herein in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the United States Patent and Trademark Office files or records, but otherwise reserves all copyright rights whatsoever.

### BACKGROUND OF THE INVENTION

1. Field of the Invention

This invention relates generally to video analysis systems and methods and, more particularly, to systems and methods for comparing and matching frames within video streams based upon representations of visual signatures or characteristics of the frames (referred to herein as “video content DNA” or “content DNA”).

2. Description of Related Art

Generally speaking, conventional methods of comparing and matching content within a video file include comparing each frame within a sequence of frames of the video using an image matching approach. As such, conventional frame-by-frame analysis of videos tends to be computationally intensive. Attempts have been made to reduce computational costs by comparing and matching content within a video using temporal and spatial matching of the frames of the video. However, a need remains for improving the efficiency and computational speed at which video analysis and matching is performed.

The inventors have discovered an approach that is based on the assumption that the precision of employing image matching techniques to video frames is precise enough and has low enough false positive rates to offer a reliable solution for finding matching videos. Further, the inventors have discovered that comparing and matching selected frames within subject videos provides improvements in computing efficiency and speed while permitting detection of common parts or sections of videos to allow for successful video matching.

### SUMMARY OF THE INVENTION

The present invention is directed to a method for identifying a plurality of videos within a corpus of reference videos matching at least one query video. The method includes providing the corpus of reference videos and receiving an input search criteria. The criteria includes the at least one query video, a parameter representing a desired search mode and a parameter representing a desired matching mode. Once the criteria is received, the method includes indexing each video in the corpus of reference videos frame by frame and determining a visual signature for each of the reference videos based on visual signatures of at least one of all frames within the reference video or a subset of frames within the reference videos. When signatures for each of the reference videos are determined, the method includes determining a visual signature of the query video and comparing the visual signatures of each video within the corpus of reference videos to the visual signature of the at least one query video, and identifying videos within the corpus of reference videos that match the at least one query video.

In one embodiment, indexing each of the reference videos includes reading each video frame by frame, comparing one frame to a next frame, and determining subsets of frames within each of the videos including anchor frames, heart beat frames and key frames. In one embodiment, a primary visual signature determined for each of the reference videos is based on the visual signatures of all frames within the reference video. In another embodiment, a secondary visual signature determined for each of the reference videos is based on the visual signatures of at least one of the subsets of frames within the reference video. In one embodiment, the comparison of the visual signatures of each reference video to the visual signature of the query video includes first comparing the secondary visual signatures to identify matches and, if no satisfactory matching results are obtained, only then determining the primary visual signatures for each reference video and comparing the primary visual signatures to the visual signature of the query video.

### BRIEF DESCRIPTION OF THE DRAWINGS

The features and advantages of the present invention will be better understood when the Detailed Description of the Preferred Embodiments given below is considered in conjunction with the figures provided, wherein:

FIG. 1 is a simplified depiction of a video including a plurality of frames (F₁-Fₓ);

FIG. 2 is a simplified depiction of a corpus of reference videos (R₁-R_{N}) and a plurality of query videos (Q₁-Q_{M}).

FIG. 3 illustrates a frame based video matching system, in accordance with one embodiment of the present invention, for identifying videos within the corpus that have frames that match one or more frames within the query videos;

FIG. 4 depicts a process flow illustrating, in accordance with one embodiment of the present invention, steps for analyzing videos in a frame based video matching process; and

FIG. 5 depicts a process flow illustrating, in accordance with one embodiment of the present invention, steps for indexing a video file.

In these figures like structures are assigned like reference numerals, but may not be referenced in the description of all figures.

### DETAILED DESCRIPTION OF THE PREFERRED EMBODIMENTS

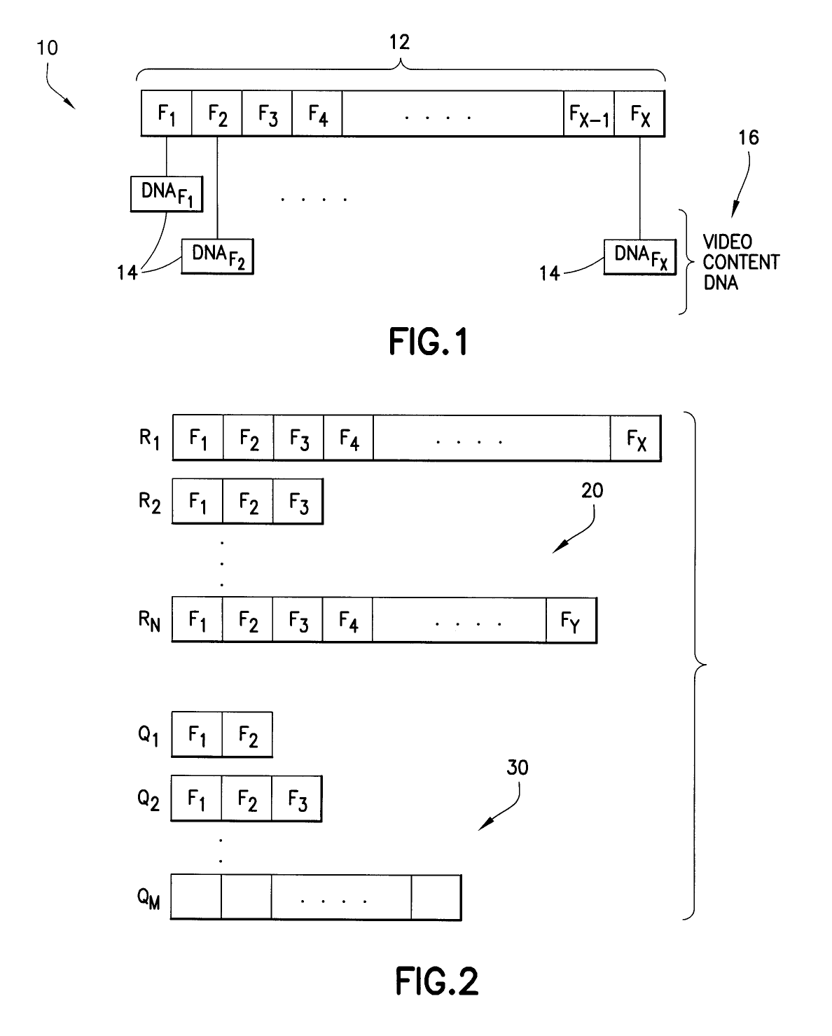

As illustrated in FIG. 1, a video 10 includes a plurality or sequence 12 of frames (F₁-Fₓ). Each frame, or a selected number of frames, is considered as a separate image such that image analysis routines may be employed to uncover videos or portions thereof that match a predetermined criterion or reference video or portion thereof. It should be appreciated that matching, as described herein, refers to identifying a degree of similarity of content within the videos or portion thereof. Similarity is based upon comparisons of representations of visual signatures or characteristics of the frames (e.g., the aforementioned video content DNA). As described in commonly owned U.S. patent application Ser. No. 12/432,119, filed Apr. 29, 2009, the disclosure of which is incorporated by reference herein, the content DNA is comprised of a plurality of visual descriptors and features representing visual properties of an image and objects therein. By using content DNA 14 (DNA F₁-DNA F_{X}) of one or more frames F₁-Fₓ, content DNA 16 for the video 10 is provided.

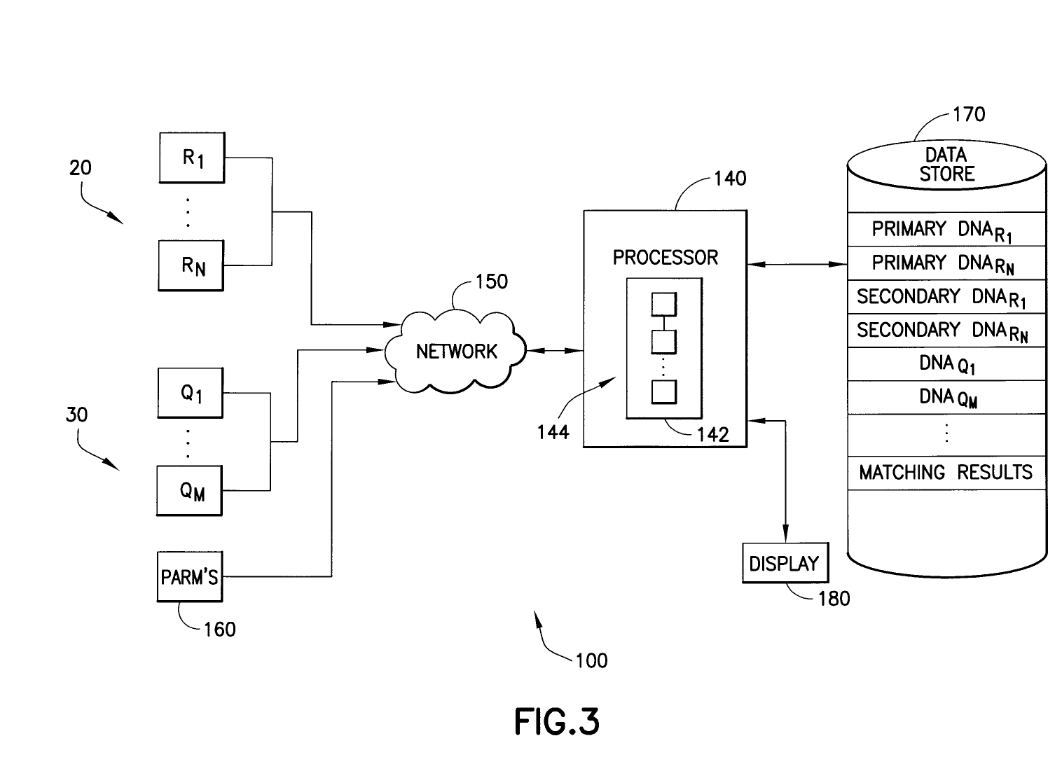

For example, FIG. 2 illustrates a typical matching approach, where a corpus 20 of reference videos R₁-R_{N} and a set 30 of query videos Q₁-Q_{M} are presented by a person initiating the match. The matching approach as described herein includes identifying videos within the corpus 20 of reference videos R₁-R_{N} that have common or matching sections or frames to each of the set of query videos Q₁-Q_{M}. As described below, the reference videos R₁-R_{N} are indexed and a visual signature is computed to provide content DNA for each of the reference videos R₁-R_{N}. As shown in FIG. 3, the present invention provides a frame based video matching system 100 implemented to identify visual information of interest within the corpus 20 to the person initiating the match. The video matching system 100 includes a processor 140 exercising a plurality of algorithms (described below) for generating a description of graphic content of frames within the reference videos R₁-R_{N}. As described herein, the video matching system 100 employs content DNA to provide more efficient and effective matching results than is achieved in conventional video search and match systems.

It should be appreciated that the processor 140 includes a computer-readable medium or memory 142 having algorithms stored therein, and input-output devices for facilitating communication over a network, shown generally at 150 such as, for example, the Internet, an intranet, an extranet, or like distributed communication platform connecting computing devices over wired and/or wireless connections, to receive and process the video data 20 and 30. The processor 140 may be operatively coupled to a data store 170. The data store 170 stores information 172 used by the system 100 such as, for example, content DNA of the reference videos R₁-R_{N} and query videos Q₁-Q_{M} as well as matching results. In one embodiment, the processor 140 is coupled to an output device 180 such as a display device for exhibiting the matching results. In one embodiment, the processor 140 is comprised of, for example, a standalone or networked personal computer (PC), workstation, laptop, tablet computer, personal digital assistant, pocket PC, Internet-enabled mobile radiotelephone, pager or like portable computing devices having appropriate processing power for video and image processing.

As shown in FIG. 3, the processor 140 includes a distributable set of algorithms 144 executing application steps to perform video recognition and matching tasks. Initially, the corpus 20 of reference videos R₁-R_{N} and the set 30 of query videos Q₁-Q_{M} are identified for processing. During a matching process, each of the query videos Q₁-Q_{M} is compared to the corpus 20 of reference videos R₁-R_{N}. For each of the query videos Q₁-Q_{M}, one goal of the frame based video matching system 100 as described herein is to find videos of the corpus 20 of reference videos R₁-R_{N} that have common parts with each of the query videos Q₁-Q_{M}. In one embodiment, the matching process is performed based upon one or more parameters 160. One of the parameters 160 of the matching system 100 is to know whether all videos in the corpus 20 of reference videos R₁-R_{N} that match a selected one of the query videos Q₁-Q_{M} should be found, or if one match is sufficient to terminate the search. If all matches within the corpus 20 of reference videos R₁-R_{N} need to be found that match the selected one of the query videos Q₁-Q_{M}, then the matching method proceeds in an “extensive search” or “exhaustive search” scenario or mode. If only one matching video needs to be found within the corpus 20 of reference videos R₁-R_{N}, then the matching process proceeds in an “alert detection” scenario or mode.

Another one of the parameters 160 of the frame based video matching process determines whether the system 100 searches for sections (e.g., sequences of one or more frames) of the selected one of the query videos Q₁-Q_{M} that match with one or more videos of the corpus 20 of reference videos R₁-R_{N} or a part thereof. When searching for sections, matching proceeds in a “sequence matching” scenario or matching mode. If the entire query video must be found in the corpus 20 of reference videos R₁-R_{N}, then the matching is done in a “global matching” scenario or matching mode. In the case of the sequence matching mode, an additional parameter represents the minimum duration (e.g., time or number of frames) of a sequence that is to be detected. This parameter is referred to as “granularity” g. Any sequence in the selected one of the query videos Q₁-Q_{M} that would be present in one of the corpus 20 of reference videos R₁-R_{N}, but with duration smaller than the granularity parameter g, may not be detected. Any sequence in the selected one of the query videos Q₁-Q_{M} with the same properties as one of the reference videos R₁-R_{N} but duration greater than the granularity parameter g is detected.

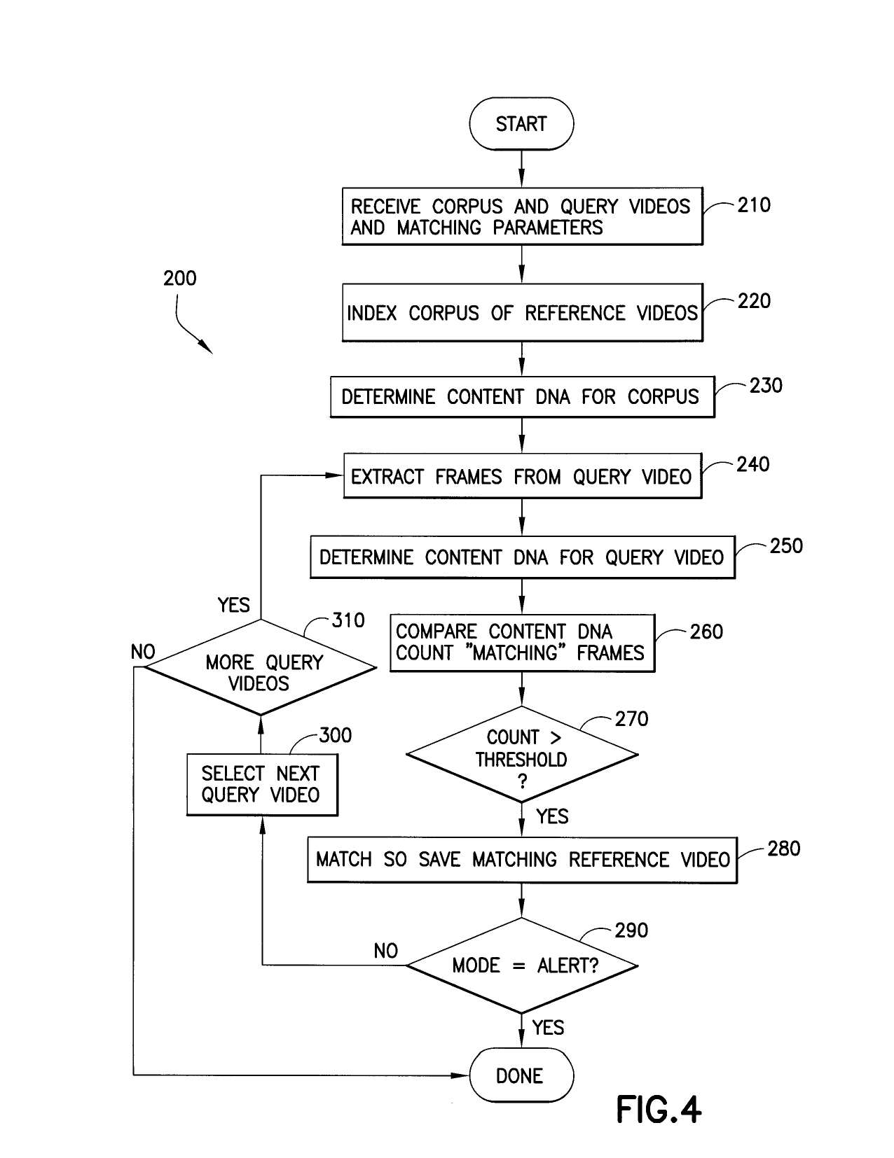

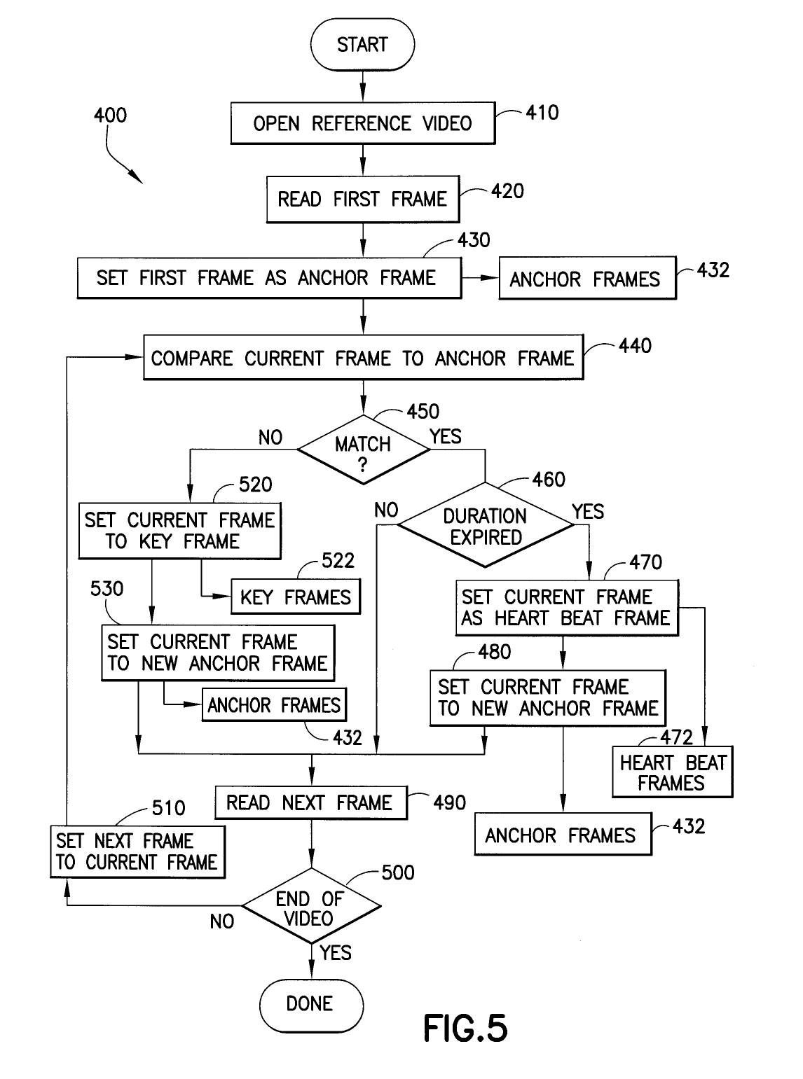

One embodiment of an inventive frame based video matching process 200 is depicted in FIG. 4. As shown in FIG. 4, the frame based video matching process 200 begins at Block 210 where the corpus 20 of reference videos R₁-R_{N}, the set 30 of query videos Q₁-Q_{M} and the matching process parameters 160 are provided to the processor 140 by, for example, a person initiating the matching process 200. At Block 220, the corpus 20 of reference videos R₁-R_{N} is indexed. In one aspect of the present invention, discussed in greater detail below, indexing includes identification of a subset of frames within each of the reference videos R₁-R_{N} from which a visual signature (video content DNA) of each reference videos R₁-R_{N} is generated and used for matching. Once indexed, at Block 230, content DNA is determined for each of the reference videos R₁-R_{N} based upon each frame or the subset of frames of the reference videos R₁-R_{N}. At Block 240, one or more frames of a selected one of the query videos Q₁-Q_{M} are processed. In one embodiment, a predetermined spacing of frames within the selected one of the query videos Q₁-Q_{M} are extracted for purposes of matching. For example, regularly spaced frames of the selected one of the query videos Q₁-Q_{M} are extracted. In one embodiment, the spacing of frames is based upon the granularity parameter g such that, for example, frames spaced by one half the granularity parameter are extracted. Once extracted, at Block 250, content DNA is determined for the selected one of the query videos Q₁-Q_{M} based upon the extracted frames.

At Block 260, the content DNA of the selected one of the query videos Q₁-Q_{M} is compared to content DNA for each of the reference videos R₁-R_{N}. During comparison, a count is maintained of all frames that the selected query video has in common with each separate one of the reference videos R₁-R_{N}. At Block 270, the count is compared to a predetermined matching threshold. If the selected one of the query videos Q₁-Q_{M} has more frames in common with a subject one of the reference videos R₁-R_{N} than the predetermined matching threshold, the subject one of the reference videos R₁-R_{N} is declared a match with the selected query video. At Block 280 the matching one of the reference videos R₁-R_{N} is tagged as matching by, for example, documenting the match in a results list, file or data set. At Block 290, the parameters 160 are evaluated to determine the matching mode of the current execution of the process 200, for example, whether the process 200 is being performed in the extensive/exhaustive matching mode or the alert detection matching mode. If the execution is being performed in the alert detection matching mode, control passes along a “Yes” path and execution ends. If the execution is being performed in the extensive/exhaustive detection matching mode, control passes along a “No” path from Block 290 and execution continues at Block 300 where a next one of the query videos Q₁-Q_{M} is selected. At Block 310 if there are no more query videos Q₁-Q_{M} to be selected, then control passes along a “No” path and execution ends. Otherwise, control passes from Block 310 along a “Yes” path and returns to Block 240 where execution continues by again performing the operations at Blocks 240 through Block 290.

The inventors have discovered that at least some of the perceived value of the frame based video matching process 200 of the present invention over conventional matching processes resides in the inventive process' simplicity and low complexity. For example, the inventive frame based video matching process 200 is an efficient and low false positives frame matching process.

As noted above, in one aspect of the present invention, each of the reference videos R₁-R_{N} are indexed (at Block 220) prior to generation of the video content DNA (at Block 230) for the reference videos. In one embodiment, a subset of frames within each of the reference videos R₁-R_{N} are identified during indexing and the visual signature (video content DNA) for the reference image is generated using the identified subset of frames. Accordingly, it is within the scope of the present invention to employ one or both of at least a primary content DNA (based on all frames within a subject video) and a secondary content DNA (based on a subset of frames within the subject video). For example, to illustrate the differences between the primary content DNA and the secondary content DNA it should be appreciated that content DNA as described herein is a local matching DNA as generated in accordance with the systems and methods described in the aforementioned commonly owned U.S. patent application Ser. No. 12/432,119, filed Apr. 29, 2009, wherein the content DNA is comprised of a plurality of visual descriptors and features representing visual properties of an image and objects therein. At least one effect of employing local matching DNA is that the resulting processing is CPU intensive. Thus, by reducing the number of frames evaluated, CPU processing is reduced. Moreover, the inventors have discovered that within many videos, matching frames are common and provide little help in uniquely identifying the overall video. Accordingly, the inventors have discovered an indexing process that identifies a subset of frames within a subject video that are more desirable for determining content DNA for matching processes. As should be appreciated, by generating content DNA only for the subset of frames, CPU processing is reduced.

FIG. 5 depicts one embodiment of an inventive indexing process 400 for the indexing step 220 of the frame based video matching process 200 (FIG. 4). As shown in FIG. 5, the indexing process 400 begins at Block 410 where a video file (e.g., one of the reference videos R₁-R_{N}) is opened by the processor 140. At Block 420, the processor 140 reads a first frame of the video file. At Block 430, the first frame is assigned as an anchor frame and as a current frame. In one embodiment, a list, record or file 432 of anchor frames is maintained. In one embodiment, the file 432 is stored in the memory 144 of the processor 140 or the data store 170 coupled to the processor 140. At Block 440, the current frame is compared to the anchor frame. In one embodiment, the comparison is made with conventional image matching techniques where visually coherent objects or zones are identified and compared. At Block 450, the results of the comparison are evaluated. In the initial execution of the indexing process 400 where both the anchor frame and the current frame are the first frame of the video, the frames match such that control passes along a “Yes” path from Block 450 to Block 460. At Block 460, a predetermined duration parameter is evaluated. In one embodiment, the duration parameter includes an indication or threshold number of consecutive frames that are allowed to match before triggering a further action. As only one frame (e.g., the first frame) has been evaluated, control passes along a “No” path from Block 460 to Block 490. At Block 490, the processor 140 reads a next frame from the video file. At Block 500, a result of the read operation of Block 490 is evaluated. If the end of the video file was reached and no next frame read, execution of the process 400 ends. Otherwise, if the read of the next frame is successful, then control passes along a “No” path from Block 500 to Block 510. At Block 510 the next frame is assigned as the current frame and the process 400 continues at Block 440 where the current frame is compared to the anchor frame.

The process 400 continues as above until the end of the video file is reached (determined at Block 500), the duration parameter is reached (determined at Block 460), or a non-matching frame is detected at Block 450. When the current frame continues to match the anchor frame and the duration expires (Block 460), control then passes along a “Yes” path from Block 460 to Block 470. At Block 470, the current frame is assigned as a heart beat frame. In one embodiment, a list, record or file 472 of heart beat frames is maintained. In one embodiment, the file 472 is stored in the memory 144 of the processor 140 or the data store 170. At Block 480, the current frame is assigned as a new instance of the anchor frame, the anchor file 432 is updated to include the current frame and control passes to Block 490 where a next frame is read, and then the operations of Block 500 are performed.

Referring again to Block 450, when the current frame is found to not match the anchor frame, control passes along a “No” path from Block 450 to Block 520. At Block 520, the current frame is assigned as a key frame. In one embodiment, a list, record or file 522 of key frames is maintained. In one embodiment, the file 522 is stored in the memory 144 of the processor 140 or the data store 170. At Block 530, the current frame is assigned as a new instance of the anchor frame, the anchor file 432 is again updated and control passes to Block 490 where a next frame is read, and then the operations of Block 500 are performed.

As noted above, the index process 400 continues until all frames of the video file (e.g., one of the reference videos R₁-R_{N}) are evaluated. At the conclusion of the index process 400 for each video file, each frame of video file has been evaluated and three subsets of the frames are determined. For example, anchor frames stored in file 432, heart beat frames stored in file 472 and key frames stored in file 522 are determined. In one embodiment, the primary DNA for a video is the local matching DNA based upon DNA determined for each frame within the video file, e.g., each frame of the subject one of the reference videos R₁-R_{N}. In one embodiment, the secondary DNA for the video is the local matching DNA based upon DNA determined for a subset of frames determined within the video file. For example, the secondary DNA is the local matching DNA based upon DNA determined for each frame within one or more of the anchor frames, the heart beat frames and key frames. It should be appreciated that if the secondary DNA is determined from the three subsets, the anchor frames, the heart beat frames and the key frames, most all consecutive duplicate or matching frames within the video file are eliminated from the DNA determination and CPU time is saved. It should also be appreciated that if the secondary DNA is determined from one subset of frames, for example, only from the key frames, even fewer frames are included in the DNA determination step so even more CPU time is saved.

Accordingly, the inventors have discovered that improved computational performance of the frame based video matching process 200 is achieved when the secondary DNA is determined at Block 230 rather than the primary DNA and when the secondary DNA is used in the matching process 200. As such, properties of the secondary DNA include: (1) being significantly faster to compute than the primary DNA; and (2) that the matching of the secondary DNA implies a match with the primary DNA.

In one embodiment, the secondary DNA is first used for detecting video frames that match between the query and reference videos. However, if a match is not found using the secondary DNA, then the computationally more complex primary DNA is computed and used in the matching step performed at Block 260. The inventors have discovered that the use of the secondary DNA improves CPU time by an average factor of about twenty (20) when indexing videos.

In one embodiment, the frame based video matching system 100 includes a kit for indexing videos made of for example, an executable program and a library reference. The program indexes a video. The program takes a video file as input, extracts its key frames and saves them into, for example, a file.

The program parameters include, for example:
video file;
an output file that typically contains, for each frame, its content DNA in binary format, a unique identifier, and optionally information including a time code of the original frame;
DNA type (e.g., descriptors employed in DNA computation);
start/in and end/out codes if only part of the video should be indexed;
frame distance threshold—default is one;
(optional) frame divider—take only one frame out of X frames. This is an optimization setting, and may be adjusted. In one embodiment, a default is a value five (5) representing instruction to take one out of every five (5) frames;
secondary DNA type—see above.

The library reference is such that the program is recursively applied and all videos within the library.

In another embodiment, frame based video matching system of the present invention includes a kit for video search and matching. The kit includes, for example:

A program to match a folder that contains videos (e.g., including the aforementioned query set Q₁-Q_{M}) with a reference database (e.g., including the aforementioned reference corpus R₁-R_{N}). In one embodiment, the program takes two folders as an input: one that contains files that make up the reference corpus R₁-R_{N}, and one that contains video files that make up the query set Q₁-Q_{M}. Other inputs are the granularity parameter, a parameter providing an indication of the searching mode (e.g., the “extensive search” or “alert detection” mode), and a parameter providing an indication of the matching mode (e.g., the “sequence matching” or “global matching” modes). Output of the executable includes a file that contains the matches detected.

Optionally, a program is provided for precisely matching two videos and validating a match. This makes it possible to run a precise comparison of two videos using the same matching process outlined above (process 200), but where matching frames are written to a disk or other memory location so that details of what matched may be reviewed. In one embodiment, the program input includes two video files, e.g., the query set Q and the reference corpus R. In one embodiment, output of the program is a set of files and frames created in, for example, an output folder.

Optionally, a program to compute statistics with respect to the outputs of the matching process 200, based on a predetermined “ground truth.” The ground truth is a set of videos that are declared matching by the person initiating the match process 200. The statistics help in computing performance and quality on a set of videos.

Although described in the context of preferred embodiments, it should be realized that a number of modifications to these teachings may occur to one skilled in the art. Accordingly, it will be understood by those skilled in the art that changes in form and details may be made therein without departing from the scope and spirit of the invention.

What is claimed is:

1. A method for identifying a plurality of videos within a corpus of reference videos matching at least one query video, the method comprising:
providing the corpus of reference videos;
receiving by a processor an input search criteria, the criteria including the at least one query video, a parameter representing a desired search mode and a parameter representing a desired matching mode;
indexing by the processor each video in the corpus of reference videos frame by frame and determining a visual signature for each of the reference videos based on visual signatures of at least one of all frames and a subset of frames of each of the reference videos;
determining by the processor a visual signature of the at least one query video;
comparing by the processor the visual signatures of each video within the corpus of reference videos to the visual signature of the at least one query video; and
identifying videos within the corpus of reference videos that match the at least one query video.

2. The method for identifying of claim 1, wherein when the desired search mode parameter indicates that an extensive/exhaustive search is to be conducted, the method identifies all videos within the corpus of reference videos that match the at least one query video.

3. The method for identifying of claim 1, wherein when the desired search mode parameter indicates that an alert detection search is to be conducted, the method identifies one videos within the corpus of reference videos that match the at least one query video.

4. The method for identifying of claim 1, wherein the step of determining the visual signature for each reference video includes determining a primary visual signature based on visual signatures of each frames of each of the reference videos.

5. The method for identifying of claim 1, wherein the step of indexing includes:
reading by the processor each of the videos of the corpus of reference videos frame by frame; and
comparing one frame to a next frame and determining the subsets of frames within each of the videos including anchor frames, heart beat frames and key frames.

6. The method for identifying of claim 5, wherein the step of determining the visual signature for each reference video includes determining a secondary visual signature based on visual signatures of each of the anchor frames, heart beat frames and the key frames of each of the reference videos.

7. The method for identifying of claim 6, wherein the step of comparing visual signatures of the reference videos to the query video includes:
comparing the secondary visual signature of each of the reference videos to the query video; and
when a match is not found, determining a primary visual signature based on visual signatures of each frames of each of the reference videos; and
comparing the primary visual signature of each of the reference videos to the query video.

8. The method for identifying of claim 5, wherein the step of determining the visual signature for each reference video includes determining a secondary visual signature based on the visual signatures of the key frames of each of the reference videos.

9. The method for identifying of claim 8, wherein the step of comparing visual signatures of the reference videos to the query video includes:
comparing the secondary visual signature of each of the reference videos to the query video; and
when a match is not found, determining a primary visual signature based on visual signatures of each frames of each of the reference videos; and
comparing the primary visual signature of each of the reference videos to the query video.
